(19) United States
(12) Patent Application Publication
(10) Pub. No.: US 2006/0257133 A1
(43) Pub. Date: Nov. 16, 2006

(54) Imaging device, processing method of the device, and program for executing the method by computer

(75) Inventor: Yasuhito Shikata, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/412,296

(22) Filed: Apr. 27, 2006

(30) Foreign Application Priority Data
Apr. 27, 2005 (JP) 2005-130608

(51) Int. Cl. G03B 17/18

(52) U.S. Cl. 396/287

(57) ABSTRACT

An imaging device includes a main image data generation unit configured to take an image and to generate main image data; a display image data generation unit configured to generate display image data to display the image on a display based on the main image data; a thumbnail image data generation unit configured to generate thumbnail image data for a thumbnail display of the image based on the main image data; a display image data information generation unit configured to generate display image data information containing the capacity of the display image data; and an image file generation unit configured to generate an image file in which the thumbnail image data, the main image data, the display image data, and the display image data information are arranged in order.

### CROSS-REFERENCE TO RELATED APPLICATIONS

The present application claims priority from Japanese Patent Application No. JP 2005-130608, filed on Apr. 27, 2005, the disclosure of which is hereby incorporated by reference herein.

### BACKGROUND OF THE INVENTION

The present invention relates to an imaging device, and particularly relates to an imaging device that quickly displays display image data to be displayed on a display, a processing method of the device, and a program for executing that method by a computer.

In an instrument for handling a still image such as a digital still camera, in serious consideration of compatibility, still image recording is performed according to DCF (Design rule for Camera File System) that is a unified standard. The DCF defines that an image in low resolution (160×120 pixels) called thumbnail and an image in high resolution (hereinafter, called main image), which depends on an imaging element such as CCD (Charge Coupled Device), are recorded in a still image. Resolution of the imaging element such as CCD has been significantly increased, and the amount of data of the main image has been increased with increase in resolution of the main image. Accordingly, time for reading the main image data recorded in a medium has been increased.

Moreover, as an image to be imaged as a preview image on a display device, the main image has been used. Today when increase in resolution of the digital still camera is advanced, sometimes the main image can not be displayed on the display device as it is because the display device has a certain limit in display performance. In this case, the resolution of the main image is converted into resolution to be adapted to display performance of the display device, so that the preview image is generated and displayed. Therefore, when the preview image is displayed on the display device, the time for reading the main image data from the medium is increased and much time is required for conversion of the resolution of the main image data due to increase in amount of data of the main image, therefore longer time has been taken before a preview picture is displayed on a display.

Regarding the above difficulties, a technique is proposed, in which a third image having a resolution that is high compared with the thumbnail and low compared with the main image is generated, and the third image is used for the preview image for example, refer to JP-A-2004-7436 (FIG. 1). In the technique, a main image is generated, then the third image is generated from the main image, and then the thumbnail is generated from the third image and thus an image file is generated and recorded. To read the third image from the image file containing the third image and display the image on the display, the image file is subjected to seek according to information stored in a header and thus the image is read out.

However, in the technique, since the main image is generated, then the third image is generated from the main image, and then the thumbnail is generated from the third image and thus the image file is generated, when the image file is generated and recorded into a recording medium, longer time is taken for generating the third image compared with the related art. Moreover, the image file needs to be wholly subjected to seek to read the third image from the medium having the image recorded therein, and consequently much time has been required for displaying the third image on the display.

Thus, it is desirable to provide an imaging device in which an image file containing a display image to be displayed on a display is quickly generated and then recorded, in addition, the display image is quickly displayed on the display.

### SUMMARY OF THE INVENTION

In an embodiment of the invention, a first aspect is an imaging device including a main image data generation unit configured to take an image and to generate main image data; a display image data generation unit configured to generate display image data to display the image on a display based on the main image data; a thumbnail image data generation unit configured to generate thumbnail image data for a thumbnail display of the image based on the main image data; a display image data information generation unit configured to generate display image data information containing the capacity of the display image data; and an image file generation unit configured to generate an image file in which the thumbnail image data, the main image data, the display image data, and the display image data information are arranged in order. This provides such operation that an image file is generated in which the display image data can be subjected to a seek operation from the end of the image data.

Moreover, in the first aspect, the display image data generation unit is configured to generate, as the display image data, image data having a lower resolution than the main image data. This provides such operation that image data having a lower resolution than the main image data are generated.

Moreover, in the first aspect, the imaging device further includes a display image data generation setting unit configured to set whether the display image data is to be generated. This provides such operation that whether the display image data is to be generated is set.

Moreover, the display image data information includes information indicating the presence of the display image data. This provides such operation that an image file, which includes the information indicating whether the display image data is present in the image file, is generated.

Moreover, the imaging device further includes a main image data compression unit configured to compress the capacity of the main image data with a compression rate that is changed depending on whether the display image data is generated. This provides such operation that increases in the capacity of the image file is prevented irrespective of whether the display image data is generated.

Moreover, in the first aspect, the thumbnail image data generation unit is configured to generate the thumbnail image data by thinning predetermined lines of the main image data. This provides such operation that the thumbnail image data is quickly generated.

Moreover, in the first aspect, the image file generating unit is configured to store the display image data information as a footer. This provides such operation that an image file storing the display image data information is generated at the end of the image file.

Moreover, in the first aspect, the display image data generation unit is configured to generate the display image data in which the capacity of the display image data is limited to a predetermined capacity or less. This provides such operation that an image file is generated in which a data area corresponding to the predetermined capacity is assigned to the display image data information and the display image data from the end of the image file.

Moreover, the display image data generation unit is configured to generate the display image data in which the capacity of the display image data is limited to the predetermined capacity or less by reducing the resolution of the main image data. This provides such operation that an image file is generated in which the data area corresponding to the predetermined capacity is assigned to the display image data information and the display image data from the end of the image file by reducing the resolution.

A second aspect of the invention is an imaging device including an image file holding unit configured to hold an image file in which thumbnail image data for thumbnail display of an image, main image data about the image, display image data to display the image on a display, and display image data information containing the capacity of the display image data are arranged in order, and the total capacity of the display image data and the display image data information is equal to a predetermined capacity or less; a fixed-length data acquisition unit configured to acquire from the image file holding unit data having the predetermined capacity from the end of the image file; a display image data extraction unit configured to extract the display image data based on the capacity of the display image data contained in the acquired data; and a display-on-display unit configured to display the display image data on the display. This provides such operation that data corresponding to a predetermined capacity are simply read from the end of the image file without performing a seek operation on the image file, and thereby the display image data are acquired and displayed on the display. Since the image file need not be subjected to a seek operation, the display image data can be quickly displayed on the display.

Moreover, a third aspect of the invention is an imaging device including an image file holding unit configured to hold an image file in which thumbnail image data for thumbnail display of an image, main image data about the image, display image data to display the image on a display, and display image data information containing the capacity of the display image data are arranged in order; a display image data information supply unit configured to acquire the display image data information from the image file holding unit and to supply the acquired information; a display image data acquisition unit configured to perform a seek operation from the end of the image file and to acquire the display image data from the image file holding unit based on the capacity of the display image data contained in the display image data information that has been supplied; and a display-on-display unit configured to display the display image data on the display. This provides such operation that a seek operation is performed from the end of the image file according to information specifying the display image data, and thereby the display image data is acquired and displayed on the display.

Moreover, in the third aspect of the invention, the image file holding unit may be configured to further hold information indicating the presence of the display image data as the display image data information; and the display image data information supply unit may include a display image data information acquisition unit configured to acquire the display image data information from the image file holding unit, and a display image data information determination unit configured to determine whether the information indicating the presence of the display image data is present in the acquired display image data information, and when the display image data information determination unit determines that the information indicating the presence of the display image data is present, it supplies the capacity of the display image data contained in the display image data information to the display image data acquisition unit. This provides such operation that when the display image data is present in the image file, the display image data is acquired by performing a seek operation from the end of the image file, and when the display image data is not present in the image file, the fact that the display image data is not present is recognized without performing a seek operation on the image file.

Moreover, the imaging device may further include a main image data acquisition unit configured to acquire the main image data from the image file holding unit when the display image data information determination unit determines that the information indicating the presence of the display image data is not present. This provides such operation that when the display image data is not present in the image file, the main image data is displayed on the display.

Moreover, a fourth aspect of the invention is a data processing method including taking an image and generating main image data; generating display image data to display the image on a display based on the main image data; generating thumbnail image data for a thumbnail display of the image based on the main image data; generating display image data information containing the capacity of the display image data; and generating an image file in which the thumbnail image data, the main image data, the display image data, and the display image data information are arranged in order, or a program for executing the method by a computer. This provides such operation that an image file is generated in which the display image data can be subjected to a seek operation from the end of the image file.

A fifth aspect of the invention is a broadcasting data processing method or a program for executing the method by a computer, including holding in order in an image file holding unit an image file in which thumbnail image data for thumbnail display of an image, main image data about the image, display image data to display the image on a display, and display image data information containing the capacity of the display image data, the total capacity of the display image data and the display image data information being equal to a predetermined capacity or less; acquiring from the image file holding unit the data having the predetermined capacity from the end of the image file; extracting the display image data based on the capacity of the display image data contained in the acquired data; and displaying the display image data on the display. This provides such operation that data corresponding to a predetermined capacity is simply read from the end of the image file without performing a seek operation on the image file, and thereby the display image data is acquired and displayed on the display. Since the image file need not be subjected to a seek operation, the display image data can be quickly displayed on the display.

A sixth aspect of the invention is a broadcasting data processing method or a program for executing the method by a computer, including holding in order in an image file holding unit an image file in which thumbnail image data for thumbnail display of an image, main image data about the image, display image data to display the image on a display, and display image data information containing the capacity of the display image data are arranged in order; acquiring the display image data information from the image file holding unit and supplying the acquired information; performing a seek operation from the end of the image file to acquire the display image data from the image file holding unit based on the capacity of the display image data contained in the display image data information that has been supplied; and displaying the display image data on the display. This provides such operation that the display image data is acquired by performing a seek operation from the end of the image file based on information specifying the display image data, and is then displayed on the display.

A seventh aspect of the invention is an image data structure including thumbnail image data for thumbnail display of an image, main image data about the image, display image data to display the image on a display, and display image data information containing the capacity of the display image data all arranged in order; wherein when a computer receives an instruction to display the image, it acquires the capacity of the display image data from the display image data information, accesses the image data structure from the end of the structure based on the capacity of the display image data to acquire the display image data, and displays the display image data on the display. This provides such operation that the display image data is acquired and displayed on the display by accessing an image file from the end of the file according to information specifying the display image data.

According to the embodiment of the invention, an excellent advantage can be exhibited: an image file containing a display image to be displayed on a display is quickly generated and recorded, and the display image is quickly displayed on the display.

### BRIEF DESCRIPTION OF THE DRAWINGS

Embodiments of the present invention will be described in detail based on the following figures, wherein:

FIG. 1 is a diagram showing an example of a configuration of an imaging device 100 of an embodiment of the invention;

FIGS. 2A to 2B are diagrams showing an example of a format of an image file generated in the imaging device 100 of the embodiment of the invention;

FIG. 3 is a diagram showing a functional configuration for generating the image file in the imaging device 100 of the embodiment of the invention;

FIGS. 4A to 4C are diagrams showing an example of configurations of three types of image files generated using a function described in FIG. 3 in the embodiment of the invention;

FIG. 5 is a diagram showing a functional configuration for displaying a display image data in the imaging device 100 of the embodiment of the invention;

FIG. 6 is a flowchart showing a flow of generating an image file in the imaging device 100 of the embodiment of the invention;

FIG. 7 is a flowchart showing a flow of displaying display image data in the image file, in which total capacity of the display image data and a footer is equal to a predetermined maximum value or less, in the imaging device 100 of the embodiment of the invention; and

FIG. 8 is a flowchart showing a flow of displaying display image data in the image file, in which the total capacity of the display image data and footer is not determined to be equal to a predetermined maximum value or less, in the imaging device 100 of the embodiment of the invention.

### DETAILED DESCRIPTION

Next, a preferred embodiment of the invention will be described in detail with reference to drawings.

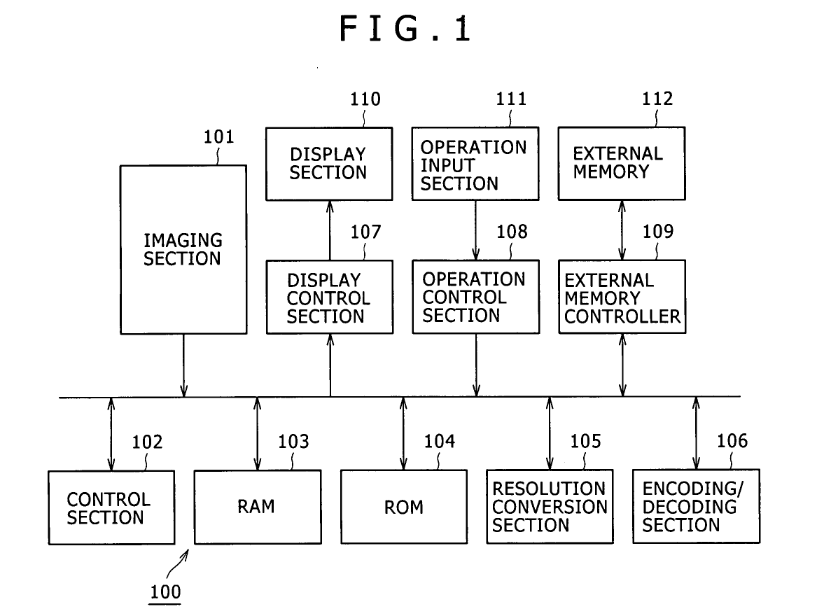

FIG. 1 is a diagram showing an example of a configuration of an imaging device 100 of the embodiment of the invention. The imaging device 100 includes an imaging section 101, a control section 102, RAM (Random Access Memory) 103, ROM (Read Only Memory) 104, a resolution conversion section 105, an encoding/decoding section 106, a display control section 107, a display section 110, an operation control section 108, an operation input section 111, an external memory controller 109, and an external memory 112.

The imaging section 101 converts an image of an object, which is injected through an optical block having a lens group for taking an image of the object, diaphragm adjustment mechanism, focus adjustment mechanism, zoom mechanism, shutter mechanism, and flash mechanism, into an imaging signal using an imaging element such as CCD, and then performs processing such as gamma correction or AGC (Auto Gain Control) to the imaging signal to generate an image signal.

The control section 102 performs processing of the overall imaging device 100, and uses the RAM 103 as working storage. In the ROM 14, a program for controlling the imaging section 101 and a program for executing control of recording and reproduction of the image signal are written.

The resolution conversion section 105 converts resolution of image data. The encoding/decoding section 106 has an encoding function for encoding the image signal from the imaging section 101 and converting the signal into compressed data. In addition, the encoding/decoding section 106 has a decoding function for decoding a compressed image signal.

The display section 110 to be connected to the display control section 107 is configured by, for example, LCD (Liquid Crystal Display), and displays the image signal from the imaging section 101 or an image signal read from the external memory 112 under control of the control section 102.

The operation input section 111 to be connected to the operation control section 108 has several keys such as a mode switching key for switching between an imaging mode and another mode such as reproduction mode, a zoom adjustment key, a key for exposure adjustment, a shutter key, and a key for adjusting display on the display section 110. The operation control section 108 transmits an operation signal from the operation input section 111 to the control section 102. The control section 102 determines which key has been operated in the operation input section 111, and performs control operation in accordance with a result of such determination.

The external memory controller 109 writes the compressed data from the encoding/decoding section 106 into the external memory 112. Moreover, the external memory controller reads the compressed data from the external memory 112 and supplies it into the encoding/decoding section 106. As the external memory 112, for example, a memory card including flash memory packaged into a card form is supposed, however, the external memory is not limited to this and may include another recoding medium. Furthermore, a configuration is acceptable, in which data are recorded in an internal memory incorporated in the imaging device 100 rather than the external memory.

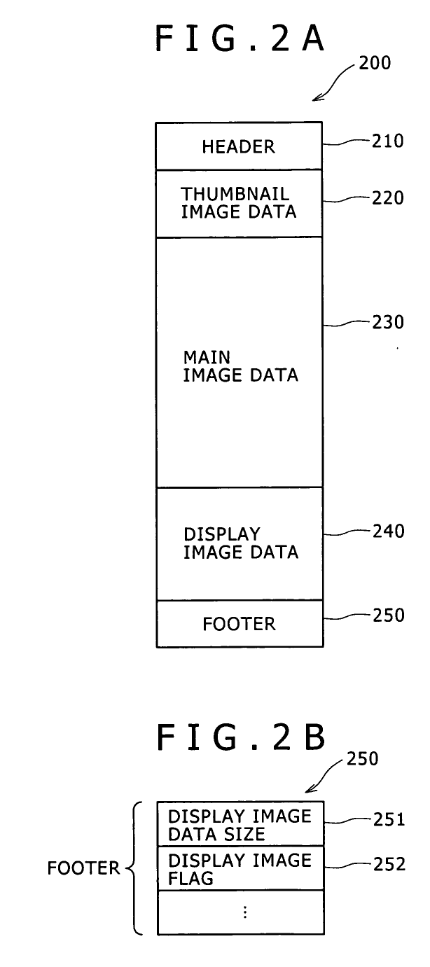

FIGS. 2A to 2B are diagrams showing an example of a format of an image file 200 generated in the imaging device 100 of the embodiment of the invention. As shown in FIG. 2A, in the image file 200, a header 210, thumbnail image data 220, main image data 230, display image data 240, and footer 250 are arranged in this order. As the format of the image file, for example, a format according to the Exif (Exchangeable Image File Format) standard is supposed.

The header 210 stores additional information such as data and time of taking the main image data. The thumbnail image data are image data that has been reduced to display a list of many recorded images. The thumbnail image data 220 may be produced by decreasing resolution of the main image data, or thinning certain lines of the main image data.

The main image data 230 are taken image data themselves, and the resolution of the main image data is different depending on performance of the imaging element such as CCD. The display image data 240 are image data used to be displayed on the display section 110. As the display image data, data that are further decreased in resolution compared with the main image data are supposed. The footer 250 is a region at the last end in the format of the image file.

In the embodiment of the invention, for example, “2560×1944” pixels are supposed as the resolution of the main image data, “640×480” pixels are supposed as resolution of the display image data, and “160×120” pixels are supposed as resolution of the thumbnail image data.

FIG. 2B is a diagram showing an example of information stored in the footer 250 in the embodiment of the invention. The footer 250 stores a display image data size 251 and a display image flag 252. The display image data size 251 indicates capacity of the display image data 240 in FIG. 2A. As the display image data size 251, for example, 200 kilobytes are supposed, however, it is merely an example and other capacity is also acceptable.

The display image flag 252 is a flag indicating whether the display image data are present in the image file or not. Even if the display image flag 252 is not provided, for example, when the display image data 240 are present in the image file 200, 16-bytes of fixed character string such as “EXTRA-IMG-EXIST\0” may be provided at the end of the footer 250 to indicate presence of the display image data 240.

The display image flag 252 is necessary when whether the display image data 240 are generated or not can be set in the imaging device 100 of the embodiment of the invention, and when the display image data 240 is always generated, the display image flag 252 may be omitted.

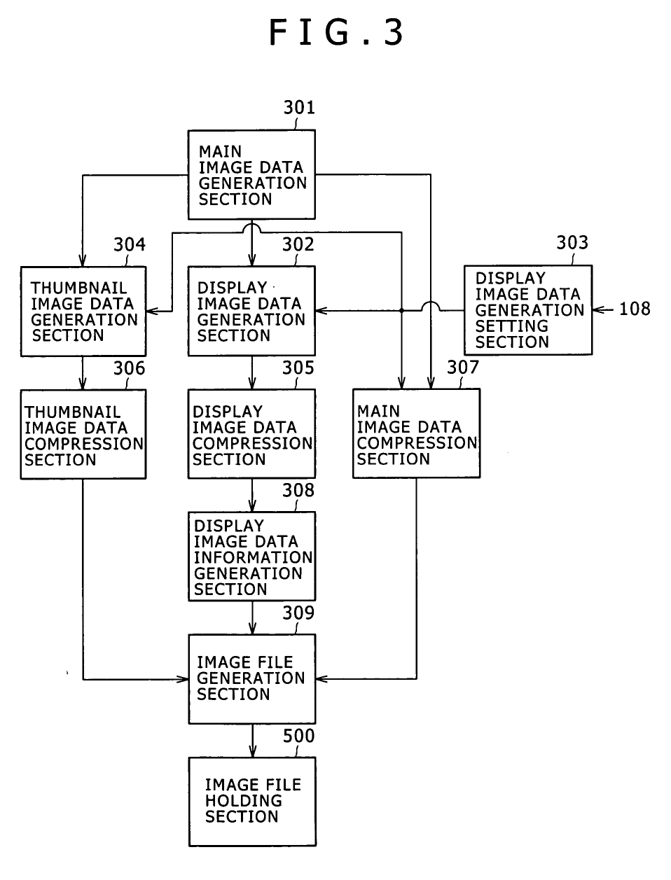

FIG. 3 shows an example of a functional configuration for generating the image file of the image taken by the imaging device 100 of the embodiment of the invention. The functional configuration includes a main image data generation section 301, a display image data generation section 302, a display image data generation setting section 303, a thumbnail image data generation section 304, a display image data compression section 305, a thumbnail image data compression section 306, a main image data compression section 307, a display image data information generation section 308, an image file generation section 309, and an image file holding section 500.

The main image data generation section 301 converts a taken image into a digital signal and generates the main image data. The main image data generation section 301 supplies generated main-image-data to the display image data generation section 302, thumbnail image data generation section 304, and main image data compression section 307.

The display image data generation section 302 generates the display image data to be displayed on the display section 110 based on the main image data supplied from the main image data generation section 301. The display image data may be generated in the display image data generation section 302, for example, by performing resolution conversion processing to make the resolution lower than that of the main image data. In this case, while the resolution of the main image data having the resolution of “2560×1944” pixels is supposed to be converted, for example, into the resolution of “640×480” pixels, it is not restrictive, and conversion can be made into another resolution.

The display image data generation setting section 303 performs setting of whether the display image data are generated or not in the display image data generation section 302. The setting is performed from the operation input section 111 through the operation control section 108. Information on the setting of whether the display image data are generated or not in the display image data generation setting section 303 is supplied to the display image data generation section 302, thumbnail image data generation section 304, and main image data compression section 307.

The thumbnail image data generation section 304 generates the thumbnail image data according to the main image data supplied from the main image data generation section 301. The thumbnail image data may be generated in the thumbnail image data generation section 304, for example, by thinning certain lines of the main image data. Moreover, the thumbnail image data may be generated in the thumbnail image data generation section 304 by performing resolution conversion processing of the main image data to make resolution to be lower than that of the main image data.

When the thumbnail image data are generated by thinning certain lines of the main image data, the thumbnail image data can be generated concurrently with generation of the display image data through conversion of the resolution of the main image data in the display image data generation section 302. It is generally difficult to perform resolution conversion processing of the main image data in the thumbnail image data generation section 304 concurrently with performing resolution conversion processing to the main image data in the display image data generation section 302, because of large amount of processing data. Therefore, the resolution conversion processing to the main image data is typically performed in the thumbnail image data generation section 302 after the resolution conversion processing to the main image data is performed in the display image data generation section 302.

However, when processing is performed in such a procedure, much time is required for generating the image file, in addition, for example, time for recording the image file into the external memory such as the memory card using flash memory is increased. On the other hand, when the thumbnail image data are generated by thinning certain lines of the main image data rather than the resolution conversion processing, the data can be generated concurrently with the resolution conversion processing of the main image data because the amount of processed data is not large in thinning processing. The display image data and the thumbnail image data are concurrently generated in this way, thereby the image file can be quickly generated, and consequently time for recording into the external memory can be reduced.

When the thumbnail image data are generated through resolution conversion of the main image data, time of about 50 to 60 milliseconds is required, however, time required for generating the thumbnail image data by thinning certain lines of the main image data can be regarded to be approximately zero seconds with respect to the time of about 50 to 60 milliseconds. Therefore, according to the embodiment of the invention, time reduction of about 50 to 60 milliseconds in total can be achieved.

On the other hand, when the display image data are set to be not generated in the display image data generation setting section 303, since the resolution conversion processing is not performed to the main image data in the display image data generation section 302, even if the thumbnail image data are generated by performing the resolution conversion processing to the main image data in the thumbnail image data generation section 304, a difficulty of increase in recording time into the external memory due to delay in image file generation does not occur.

The display image data compression section 305 encodes and compresses the display image data generated in the display image data generation section 302. The thumbnail image data compression section 306 encodes and compresses the thumbnail image data generated in the thumbnail image data generation section 304. The main image data compression section 307 encodes and compresses the main image data generated in the main image data generation section 301. Such encoding of the display image data, thumbnail image data, and main image data is performed according to, for example, the Exif standard.

The main image data compression section 307 encodes and compresses the main image data with a compression rate that is changed depending on content of setting in the display image data generation setting section 303. That is, the main image data are compressed with a low compression rate in the case that the display image data is set to be generated in the display image data generation setting section 303 compared with the case that the display image data is set to be not generated. According to this, total capacity of the image file can be made to be within a predetermined range irrespective of whether the display image data is generated or not. Consequently, time is not increased for recording the image file into a recording medium such as the external memory.

The display image data information generation section 308 generates information (hereinafter, called display image data information) indicating capacity of the display image data or presence of the display image data. The information indicating the capacity of the display image data is information corresponding to the display image data size 251 in FIG. 2B, and the information indicating the presence of the display image data is information corresponding to the display image flag 252 in FIG. 2B.

The image file generation section 309 generates an image file, in which the thumbnail image data, main image data, display image data, and display image data information are arranged in this order, based on the data supplied from the thumbnail image data compression section 306, main image data compression section 307 and display image data information generation section 308. The image file generation section 309 generates the image file, and then supplies a generated image file to the image file holding section 500 in which the file is held.

The main image data generation section 301 can be realized, for example, by the imaging section 101 and the control section 102. The display image data generation section 302 and the thumbnail image data generation section 304 can be realized, for example, by the control section 102 and the resolution conversion section 105. The display image data generation setting section 303 and the display image data information generation section 308 can be realized, for example, by the control section 102. The display image data compression section 305 and the thumbnail image data compression section 306, and the main image data compression section 307 can be realized, for example, by the control section 102 and the encoding/decoding section 106. The image file generation section 309 can be realized, for example, by the control section 102 and the external memory controller 109. The image file holding section 500 can be realized, for example, by the external memory 112.

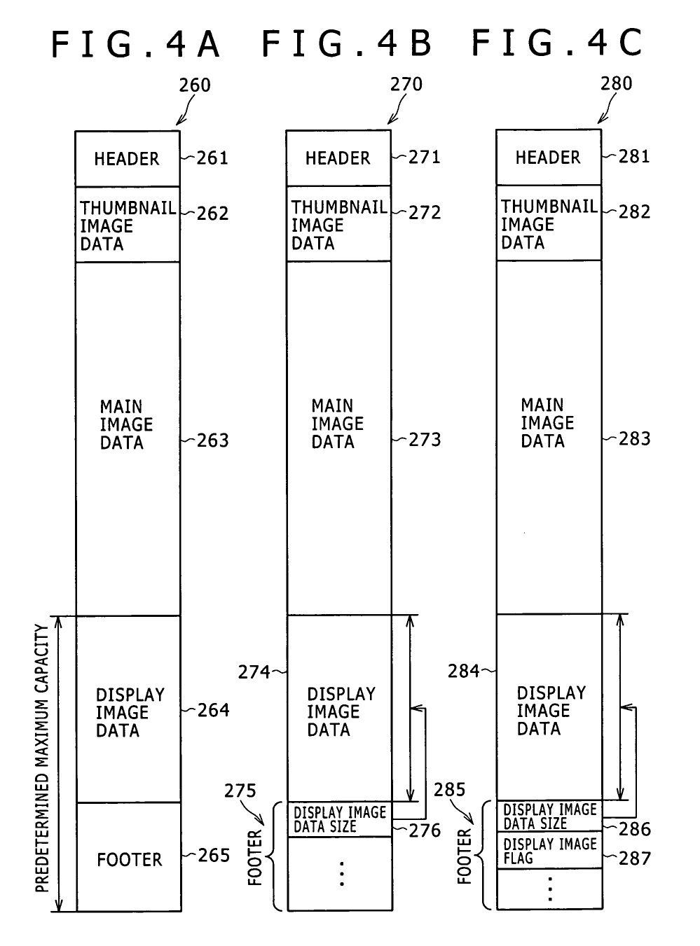

FIGS. 4A to 4C are diagrams showing an example of configurations of three types of image files generated using the function described in FIG. 3, in the embodiment of the invention. In a configuration of the image file shown in FIG. 4A, a header 261, thumbnail image data 262, main image data 263, display image data 264, and a footer 265 are arranged in this order similarly as described in FIG. 2A. The image file shown in FIG. 4A has a feature in that the maximum total value of capacity of the display image data 264 and the footer 265 is determined.

In this case, even if seek is not performed to the image file 260 as a whole to acquire the display image data 264 from the image file 260, if data in a region of the maximum capacity value are acquired from the end of the image file 260, since the display image data 264 are necessarily contained in the data, the display image data 264 can be easily and quickly acquired. Thus, the display image data 264 can be quickly displayed on a display. Seek is not necessary in this way, which can reduce time of about 100 milliseconds or less before the display image data 264 are displayed on the display section 110.

In an image file 270 shown in FIG. 4B, a header 271, thumbnail image data 272, main image data 273, display image data 274, and a footer 275 are arranged in this order similarly as described in FIG. 2A. The image file 270 shown in FIG. 4B has a feature in that while a display image data size is contained in the footer 275, the display image flag is not contained.

The display image flag is information which is not necessary when the display image data generation setting section 303 is not provided in the imaging device 100 of the embodiment of the invention, and necessary when the display image data generation setting section 303 is provided. That is, when the display image data generation setting section 303 is provided, the display image data are sometimes not generated. Therefore, when the display image data generation setting section 303 is provided in the imaging device 100, information indicating whether the display image data are present or not in the image file, such as the display image flag in the embodiment of the invention, is necessary. The information is equivalent to the display image flag. The image file shown in FIG. 4B is supposed as an image file generated from the imaging device 100 in which the display image data generation setting section 303 is not provided. In this case, since the display image data are always generated, the display image flag is not contained.

In an image file 280 shown in FIG. 4C, a header 281, thumbnail image data 282, main image data 283, display image data 284, and a footer 285 are arranged in this order similarly as described in FIG. 2A. The image file 280 shown in FIG. 4C has a feature in that a display image data size 286 and a display image flag 287 are contained in the footer 285. The image file 280 shown in FIG. 4C is supposed as an image file generated from the imaging device 100 in which the display image data generation setting section 303 is provided. In this case, since the display image data are sometimes not generated as described before, the display image flag is contained.

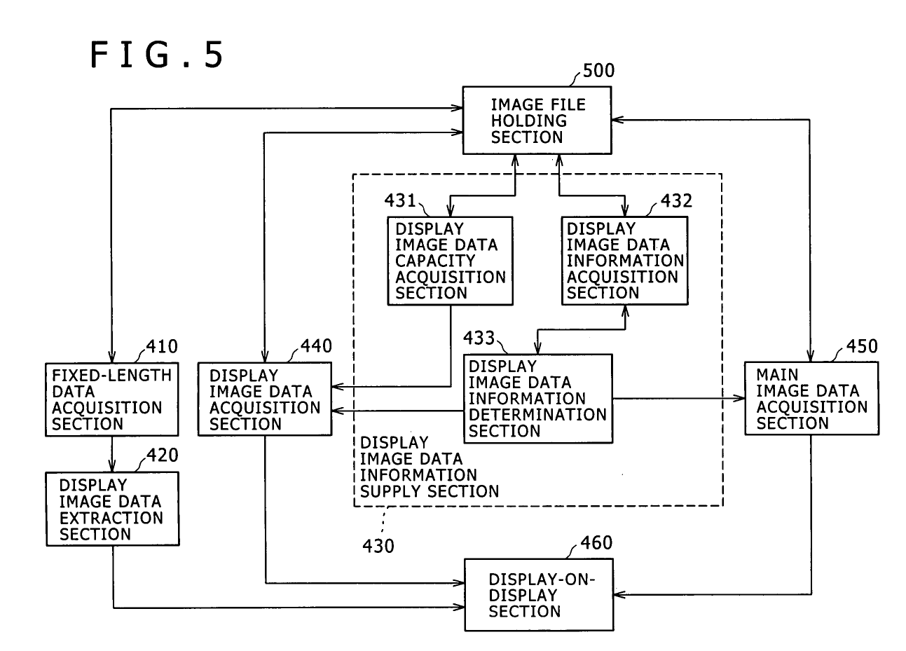

FIG. 5 is a diagram showing an example of a functional configuration for displaying the display image data in the imaging device 100 of the embodiment of the invention. The functional configuration includes an image file holding section 500, a fixed-length data acquisition section 410, a display image data extraction section 420, a display image data information supply section 430, a display image data acquisition section 440, a main image data acquisition section 450, and a display-on-display section 460. The display image data information supply section 430 includes a display image data capacity acquisition section 431, a display image data information acquisition section 432, and a display image data information determination section 433.

The image file holding section 500 holds the image file shown in FIG. 2A. As modes of the image file held herein, three modes are supposed in the embodiment of the invention as described in FIGS. 4A to 4C. Functions shown in FIG. 5 are to display display-image-data contained in the three image files different in mode on a display. Hereinafter, each of the functions is described for each of the modes of the image file.

First, description is made on a function of displaying the display image data 264 in the image file 260, in which the maximum value of total capacity of the display image data 264 and the footer 265 is determined, on the display. In the case of the image file 260 shown in FIG. 4A, the display image data 264 are acquired in the fixed-length data acquisition section 410 and the display image data extraction section 420, and the display image data 264 are supplied to the display-on-display section 460. Each function is specifically described below.

The fixed-length data acquisition section 410 acquires data corresponding to capacity corresponding to the maximum value from the end of the image file 260 from the image file holding section 500. The fixed-length data acquisition section 410 supplies such acquired data to the display image data extraction section 420.

The display image data extraction section 420 extracts the display image data 264 from the data supplied from the fixed-length data acquisition section 410 based on display image data size stored in the footer 265 in the data supplied from the fixed-length data acquisition section 410. The display image data extraction section 420 supplies such extracted display image data 264 to the display-on-display section 460. The display-on-display section 460 displays supplied display image data 264.

Next, description is made on functions of displaying the display image data 274 in the image file 270, in which the display image flag shown in FIG. 4B is not contained, on the display. In the case of the image file 270 shown in FIG. 4B, the display image data 274 are acquired in the display image data capacity acquisition section 431 and the display image data acquisition section 440, and the display image data 274 are supplied to the display-on-display section 460. Each of the functions is specifically described below.

The display image data capacity acquisition section 431 acquires display image data information containing the display image data size 276 stored in the footer 275 from the image file holding section 500. The display image data capacity acquisition section 431 supplies the information such as display image data size 276 contained in such acquired display image data information to the display image data acquisition section 440.

The display image data acquisition section 440 performs seek to the image file holding section 500 according to the information such as display image data size 276 supplied from the display image data capacity acquisition section 431 and thus acquires the display image data 274. The display image data acquisition section 440 supplies acquired display image data 274 to the display-on-display section 460. The display-on-display section 460 displays supplied display image data 274.

Next, description is made on functions of displaying the display image data 284 in the image file 280, in which the display image flag shown in FIG. 4C is contained, on the display. In the case of the image file 280 shown in FIG. 4C, the display image data 284 or the main image data 283 are acquired from the image file holding section 500 in the display image data information acquisition section 432, display image data information determination section 433, display image data acquisition section 440, and main image data acquisition section 450, and the display image data 284 or the main image data 283 are supplied to the display-on-display section 460. Each of the functions is specifically described below.

The display image data information acquisition section 432 acquires display image data information containing the display image data size 286 and the display image flag 287 stored in the footer 285 from the image file holding section 500. The display image data information acquisition section 432 supplies such acquired display image data information to the display image data information determination section 433.

The display image data information determination section 433 determines whether the display image flag 287 is set or not in the display image data information supplied from the display image data information acquisition section 432. When the display image data information determination section 433 determines the display image flag 287 is set, the display image data information determination section 433 supplies the information such as the display image data size 286 contained in the display image data information to the display image data acquisition section 440.

When the display image data acquisition section 440 is supplied with the information such as the display image data size 286 as described before, it performs seek to the image file holding section 500 and thus acquires the display image data 284. The display image data acquisition section 440 supplies acquired display image data 284 to the display-on-display section 460. The display-on-display section 460 displays supplied display image data 274. On the other hand, when the display image data information determination section 433 determines the display image flag 287 is not set, the display image data information determination section 433 acquires information such as data size on the main image data from the image file holding section 500 and then supplies the information to the main image data acquisition section 450.

When the main image data acquisition section 450 receives the information such as the data size on the main image data, it performs seek to the image file holding section 500 and thus acquires the main image data 283. The main image data acquisition section 450 supplies acquired main-image-data 283 to the display-on-display section 460. The display-on-display section 460 displays supplied main-image-data 283.

The image file holding section 500 is realized, for example, by the external memory 112. The fixed-length data acquisition section 410, display image data capacity acquisition section 431, and display image data information acquisition section 432 can be realized, for example, by the control section 102 and the external memory controller 109. The display image data information determination section 433 can be realized, for example, by the control section 102. The display image data extraction section 420, display image data acquisition section 440, and main image data acquisition section 450 can be realized, for example, by the control section 102, resolution conversion section, and encoding/decoding section 106. The display-on-display section 460 can be realized, for example, by the display control section 107 and the display section 110.

Next, operation of the imaging device 100 of the embodiment of the invention is described with reference to drawings.

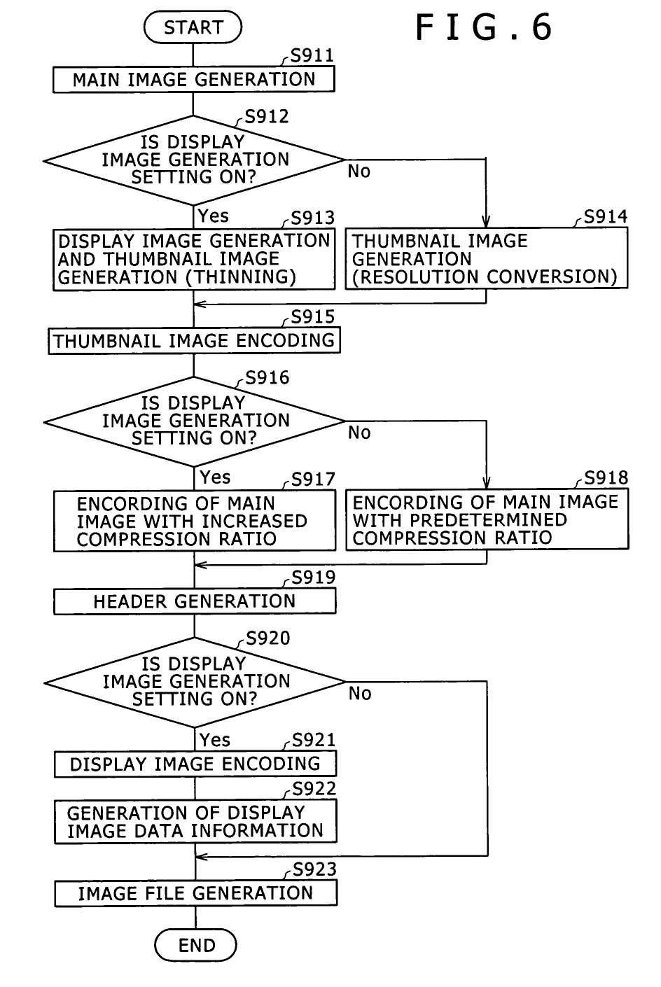

FIG. 6 is a flowchart showing a flow of generating the image file in the imaging device 100 of the embodiment of the invention. First, an object image is taken and then main image data are generated in the main image data generation section 301 (S911). Next, the display image data generation section 302 determines whether the display image data are set to be generated or not in the display image data generation setting section 303 (S912).

When the display image data generation section 302 determines the display image data are set to be generated, the section 302 generates the display image data and the thumbnail image data based on the main image data (S913). The display image data may be generated, for example, by further decreasing the resolution of the main image data as described before. On the other hand, the thumbnail image data generation section 304 generates the thumbnail image data based on the main image data.

When the thumbnail image data generation section 304 determines the display image data are set to be generated, the thumbnail image data generation section 304 generates the thumbnail image data by thinning the certain lines of the main image data. On the other hand, when the thumbnail image data generation section 304 determines the display image data are not set to be generated, the section 304 generates the thumbnail image data by further decreasing the resolution of the main image data (914).

In this way, generation methods of the thumbnail image data are changed depending on whether the display image data are generated or not, which is for reducing time for generating the image file and recording the file into the external memory after taking the object image. That is, when the thumbnail image data is assumed to be generated by resolution conversion of the main image data at any times, since the main image data are subjected to resolution conversion two times in generation of the display image data and generation of the thumbnail image data as described before, much time is required for generating the image file and recording the file into the external memory. Therefore, when the main image data are generated, the thumbnail image data are assumed to be generated by thinning the certain lines of the main image data, since time required for processing of thinning the certain lines of the main image data is so short that it can be neglected compared with time in resolution conversion processing of the main image data, a difficulty of increase in recording time due to delay in generation of the image file does not occur. However, if the display image data are not generated, since the main image data are not subjected to resolution conversion two times, the difficulty of increase in recording time due to delay in generation of the image file does not occur even if the resolution conversion of the main image data is performed in generation of the thumbnail image data.

When the thumbnail image data are generated, the thumbnail image data are encoded in the thumbnail image data compression section 306 (S915). Next, as preprocessing for encoding the main image data, the main image data compression section 307 determines whether the display image data are set to be generated or not in the display image data generation setting section 303 (S916).

When the main image data compression section 307 determines the display image data are not set to be generated, the section 307 encodes the main image data with a predetermined compression rate (S918). On the other hand, when the main image data compression section 307 determines the display image data are set to be generated, the section 307 encodes the main image data with a compression rate higher than the predetermined compression rate (S917).

A purpose of changing the compression rate depending on whether the display image data are generated or not in this way is for reducing time for recording the image file. When the compression rate is increased, since the data capacity of the main image data is correspondingly decreased, recording time into the external memory is reduced. Another purpose is for reducing seek-time of the display image data as a target from the image file holding section 500. That is, when the display image data are generated, capacity of the image file is correspondingly increased. When the capacity of the image file is increased, the seek time of the display image data as a target is increased by a level corresponding to increase in capacity. To reduce time for seek of the display image data, the compression rate needs to be increased in encoding so that the capacity of the image file is not increased. Therefore, the compression rate is changed depending on whether the display image data are generated or not in the embodiment of the invention.

After the main image data are encoded, a header is generated (S919). When the header is generated, the display image data compression section 305 determines whether the display image data are set to be generated or not in the display image data generation setting section 303 (S920). When the display image data compression section 305 determines the display image data are not set to be generated, an image file is generated, in which the header, thumbnail image data, and main image data are arranged in this order (S923); and then processing is finished.

On the other hand, when the display image data compression section 305 determines the display image data are set to be generated, the display image data are encoded with a predetermined compression rate (S921), and a footer that stores the display image data information containing the display image data size and the display image flag is generated (S922). Then, an image file is generated and recorded, in which the header, the thumbnail image data, main image data, display image data, and the footer storing the display image data information, which are generated in the above steps, are arranged in this order (S923); and then the processing is finished.

When setting of whether the display image data are generated or not is not given, the image file is generated without performing the processing or determination of the steps S912, S915, S917, S918 and S921. Similarly in the case of an image file in which capacity of the total display image data and the footer is equal to a predetermined maximum value or less, the image file is still generated without performing the above steps. In the case of the image file in which the total capacity of the display image data and the footer is equal to the predetermined maximum value or less, resolution conversion is further performed in generation of the display image data in the step S913 such that the total capacity of the display image data and the footer is equal to the predetermined maximum value or less.

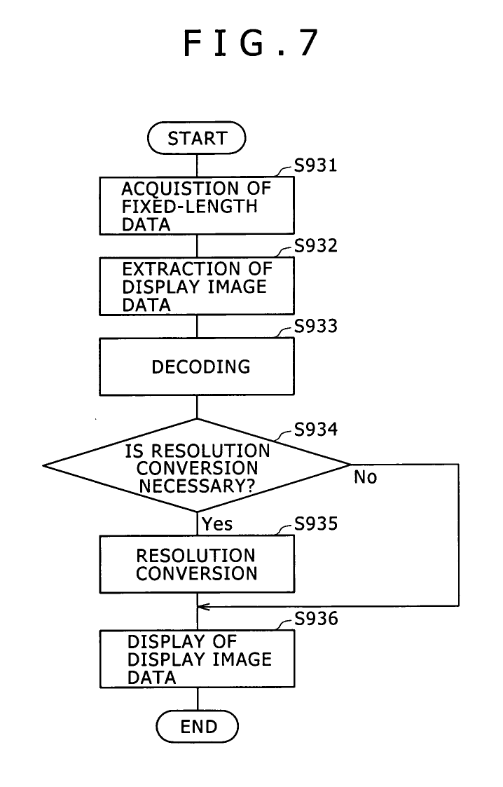

FIG. 7 is a flowchart showing a flow of displaying a display image data in the image file in which the total capacity of the display image data and the footer is equal to the predetermined maximum value or less, in the imaging device 100 of the embodiment of the invention.

The fixed-length data acquisition section 410 acquires the capacity corresponding to the predetermined maximum value from the end of the image file from the image file holding section 500 (S931). The fixed-length data acquisition section 410 supplies such acquired data to the display image data extraction section 420. When the display image data extraction section 420 is supplied with the data, it extracts the display image data from the supplied data based on the display image data size stored in the footer contained in the data (S932). Then, such extracted display image data are decoded (S934).

When resolution of decoded display image data is beyond display performance of the display-on-display section 460 in the imaging device of the embodiment of the invention, the resolution of the display image data needs to be converted to be adapted to the display performance of the display-on-display section 460. Therefore, whether resolution conversion is necessary or not is determined (S934). When the resolution conversion is determined to be necessary, processing of resolution conversion of the display image data is performed (S935). When the resolution of the display image data is converted to be adapted to the display performance of the display-on-display section 460, the display image data are displayed on the display-on-display section 460 (S936).

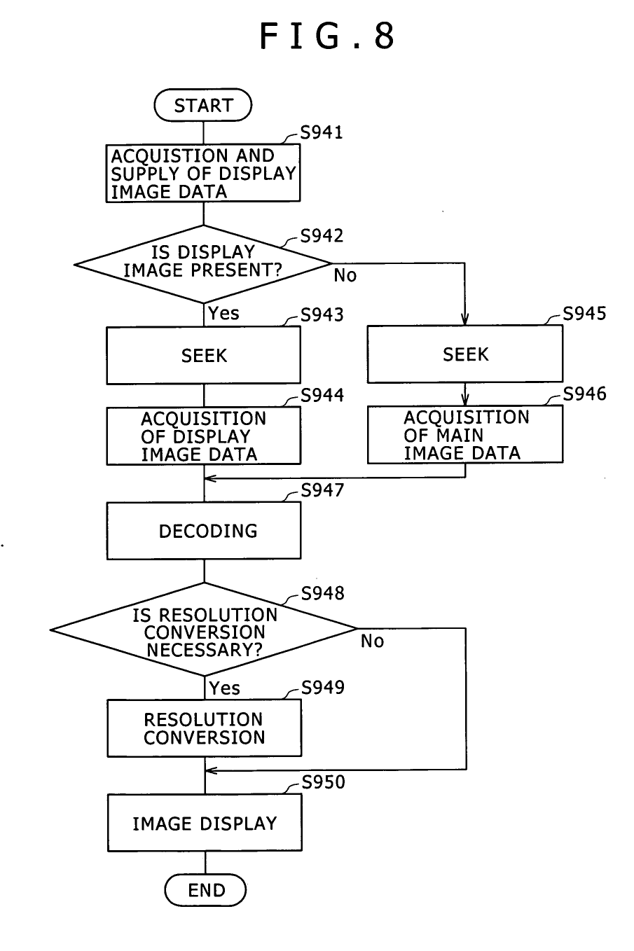

FIG. 8 is a flowchart showing a flow of displaying a display image data in an image file in which the total capacity of the display image data and the footer is not determined to be equal to the predetermined maximum value or less unlike the case in FIG. 7, in the imaging device 100 of the embodiment of the invention.

The display image data information acquisition section 432 acquires the display image data information stored in the footer from the image file holding section 500. Then, the display image data information acquisition section 432 supplies such acquired display image data information to the display image data information determination section 433 (S941).

The display image data information determination section 433 determines whether the relevant display image data are present or not according to the display image data information supplied from the display image data information acquisition section 432 (S942). Such determination is made, for example, according to whether the display image flag is set in the display image data information or not.

When the display image data information determination section 433 determines the display image data are present in the relevant image file, the display image data information determination section 433 supplies information such as the display image data size contained in the display image data information to the display image data acquisition section 440. When the display image data acquisition section 440 is supplied with the information such as the display image data size, it performs seek to the image file holding section 500 (S943), and then acquires corresponding display image data (S944).

On the other hand, when the display image data information determination section 433 determines the display image data are not present in the relevant image file, the display image data information determination section 433 acquires information such as data size on the main image data from the image file holding section 500 and then supplies the information to the main image data acquisition section 450. When the main image data acquisition section 450 is supplied with the information such as the data size on the main image data, it performs seek to the image file holding section 500 (S945), and then acquires corresponding main image data (S946).

The display image data or the main image data acquired in the step S944 or the step S946 are decoded (S947). When resolution of decoded display-image-data or main-image-data is beyond the display performance of the display-on-display section 460, the resolution of the display image data or the main image data needs to be converted to be adapted to the display performance of the display-on-display section 460. Therefore, whether resolution conversion is necessary or not is determined (S948). When the resolution conversion is determined to be necessary, processing of resolution conversion is performed to the display image data or the main image data (S949). When the processing of resolution conversion has been performed such that the resolution is adapted to the display performance of the display-on-display section 460, the display image data or the main image data is displayed on the display-on-display section 460 (S950).

While a flow of processing of an image file in which whether the display image data are contained is changeable has been shown hereinbefore, in processing on an image file in which the display image data are contained at any time, the display image data are displayed without performing processing or determination of the steps S942, S945 and S946.

The embodiment of the invention has been shown as an example for embodying the invention, and while the embodiment of the invention has correspondence relationships with invention-specifying-items in claims respectively as shown below, it is not limited to those and can be modified variously without departing from the gist of the invention.

That is, In the application concerned, a main image data generation unit corresponds to, for example, the main image data generation section 301. A display image data generation unit corresponds to, for example, the display image data generation section 302. A thumbnail image data generation unit corresponds to, for example, the thumbnail image data generation section 304. A display image data information generation unit corresponds to, for example, the display image data information generation section 308. An image file generation unit corresponds to, for example, the image file generation section 309.

In the application concerned, a display image data generation setting unit corresponds to, for example, the display image data generation setting section 303.

In the application concerned, a main image data compression unit corresponds to, for example, the main image data compression section 307.

In the application concerned, an image file holding unit corresponds to, for example, the image file holding section 500. A fixed-length data acquisition unit corresponds to, for example, the fixed-length data acquisition section 410. A display image data extraction unit corresponds to, for example, the display image data extraction section 420. A display-on-display unit corresponds to, for example, the display-on-display section 460.

In the application concerned, an image file holding unit corresponds to, for example, the image file holding section 500. A display image data information supply unit corresponds to, for example, the display image data information supply section 430. A display image data acquisition unit corresponds to, for example, the display image data acquisition section 440. A display-on-display unit corresponds to, for example, the display-on-display section 460.

In the application concerned, a display image data information acquisition unit corresponds to, for example, the display image data information acquisition section 432. A display image data information determination unit corresponds to, for example, the display image data information determination section 433.

In the application concerned, a main image data acquisition unit corresponds to, for example, the main image data acquisition section 450.

In the application concerned, a main image data generation procedure corresponds to the step S911. A display image data generation procedure corresponds to, for example, the step S913. A thumbnail image data generation procedure corresponds to, for example, the step S913 or the step S914. A display image data information generation procedure corresponds to, for example, the step S922. An image file generation procedure corresponds to, for example, the step S923.

In the application concerned, a fixed-length data acquisition procedure corresponds to, for example, step S931. A display image data extraction procedure corresponds to, for example, step S932. A display-on-display procedure corresponds to, for example, the step S934 to the step S936.

In the application concerned, a display image data information supply procedure corresponds to, for example, the step S941 and the step S942. A display image data acquisition procedure corresponds to, for example, the step S943 and the step S944. A display-on-display procedure corresponds to, for example, the step S948 to the step S950.

In the application concerned, a main image data generation step corresponds to the step S911. A display image data generation step corresponds to, for example, the step S913. A thumbnail image data generation step corresponds to, for example, the step S913 or the step S914. A display image data information generation step corresponds to, for example, the step S922. An image file generation step corresponds to, for example, the step S923.

In the application concerned, a fixed-length data acquisition step corresponds to, for example, step S931. A display image data extraction step corresponds to, for example, step S932. A display-on-display step corresponds to, for example, the step S934 to the step S936.

In the application concerned, a display image data information supply step corresponds to, for example, the step S941 and the step S942. A display image data acquisition step corresponds to, for example, the step S943 and the step S944. A display-on-display step corresponds to, for example, the step S948 to the step S950.

The processing and procedure described in the embodiment of the invention may be regarded as methods including the series of procedures, or may be regarded as a program for executing the series of procedures or a recording medium for storing the program.

It should be understood by those skilled in the art that various modifications, combinations, sub-combinations and alterations may occur depending on design requirements and other factors insofar as they are within the scope of the appended claims or the equivalents thereof.

1. An imaging device, comprising:
a main image data generation unit configured to take an image and to generate main image data;
a display image data generation unit configured to generate display image data to display the image on a display based on the main image data;
a thumbnail image data generation unit configured to generate thumbnail image data for a thumbnail display of the image based on the main image data;
a display image data information generation unit configured to generate display image data information containing the capacity of the display image data; and
an image file generation unit configured to generate an image file in which the thumbnail image data, the main image data, the display image data, and the display image data information are arranged in order.

2. The imaging device according to claim 1, wherein the display image data generation unit is configured to generate, as the display image data, image data having a lower resolution than the main image data.

3. The imaging device according to claim 1, further comprising
a display image data generation setting unit configured to set whether the display image data is to be generated.

4. The imaging device according to claim 1, wherein the display image data information includes information indicating the presence of the display image data.

5. The imaging device according to claim 3, further comprising
a main image data compression unit configured to compress the capacity of the main image data with a compression rate that is changed depending on whether the display image data is generated.

6. The imaging device according to claim 1, wherein the thumbnail image data generation unit is configured to generate the thumbnail image data by thinning predetermined lines of the main image data.

7. The imaging device according to claim 1, wherein the image file generation unit is configured to store the display image data information as a footer.

8. The imaging device according to claim 1, wherein the display image data generation unit is configured to generate the display image data in which the capacity of the display image data is limited to a predetermined capacity or less.

9. The imaging device according to claim 8, wherein the display image data generation unit is configured to generate the display image data in which the capacity of the display image data is limited to the predetermined capacity or less by reducing the resolution of the main image data.

10. An imaging device, comprising:
an image file holding unit configured to hold an image file in which thumbnail image data for thumbnail display of an image, main image data about the image, display image data to display the image on a display, and display image data information containing the capacity of the display image data are arranged in order, and the total capacity of the display image data and the display image data information is equal to a predetermined capacity or less;
a fixed-length data acquisition unit configured to acquire from the image file holding unit data having the predetermined capacity from the end of the image file;
a display image data extraction unit configured to extract the display image data based on the capacity of the display image data contained in the acquired data; and
a display-on-display unit configured to display the display image data on the display.

11. An imaging device, comprising:
an image file holding unit configured to hold an image file in which thumbnail image data for thumbnail display of an image, main image data about the image, display image data to display the image on a display, and display image data information containing the capacity of the display image data are arranged in order;
a display image data information supply unit configured to acquire the display image data information from the image file holding unit and to supply the acquir3ed information;
a display image data acquisition unit configured to perform a seek operation from the end of the image file to acquire the display image data from the image file holding unit based on the capacity of the display image data contained in the display image data information that has been supplied; and
a display-on-display unit configured to display the display image data on the display.

12. The imaging device according to claim 11, wherein
the image file holding unit is configured to further hold information indicating the presence of the display image data as the display image data information, and
the display image data information supply unit includes:
a display image data information acquisition unit configured to acquire the display image data information from the image file holding unit, and
a display image data information determination unit configured to determine whether the information indicating the presence of the display image data is present in the acquired display image data information, and when the display image data information determination unit determines that the information indicating the presence of the display image data is present, it supplies the capacity of the display image data contained in the display image data information to the display image data acquisition unit.

13. The imaging device according to claim 12, further comprising
a main image data acquisition unit configured to acquire the main image data from the image file holding unit when the display image data information determination unit determines that the information indicating the presence of the display image data is not present.

14. A data processing method, comprising:
taking an image and generating main image data;
generating display image data to display the image on a display based on the main image data;
generating thumbnail image data for a thumbnail display of the image based on the main image data;
generating display image data information containing the capacity of the display image data; and
generating an image file in which the thumbnail image data, the main image data, the display image data, and the display image data information are arranged in order.

15. A data processing method, comprising:
holding in order in an image file holding unit an image file including thumbnail image data for thumbnail display of an image, main image data about the image, display image data to display the image on a display, and display image data information containing the capacity of the display image data, the total capacity of the display image data and the display image data information being equal to a predetermined capacity or less;
acquiring from the image file holding unit the data having the predetermined capacity from the end of the image file;
extracting the display image data based on the capacity of the display image data contained in the acquired data; and
displaying the display image data on the display.

16. A data processing method, comprising:
holding in order in an image file holding unit an image file including thumbnail image data for thumbnail display of an image, main image data about the image, display image data to display the image on a display, and display image data information containing the capacity of the display image data;
acquiring the display image data information from the image file holding unit and supplying the acquired information;
performing a seek operation from the end of the image file to acquire the display image data from the image file holding unit based on the capacity of the display image data contained in the display image data information that has been supplied; and
displaying the display image data on the display.

17. A program for executing a data processing method, comprising:
taking an image and generating main image data;
generating display image data to display the image on a display based on the main image data;
generating thumbnail image data for a thumbnail display of the image according to the main image data;
generating display image data information containing the capacity of the display image data; and
generating an image file in which the thumbnail image data, the main image data, the display image data, and the display image data information are arranged in order.

18. A program for executing a data processing method by an imaging device including an image file holding unit that holds an image file in which thumbnail image data for a thumbnail display of an image, main image data about the image, display image data to display the image on a display, and display image data information containing the capacity of the display image data are arranged in order, and the total capacity of the display image data and the display image data information is equal to a predetermined capacity or less, the data processing method comprising:
acquiring from the image file holding unit the data having the predetermined capacity from the end of the image file;
extracting the display image data based on the capacity of the display image data contained in the acquired data; and
displaying the display image data on the display.

19. A program for executing a data processing method by an imaging device including an image file holding unit that holds an image file in which thumbnail image data for thumbnail display of an image, main image data about the image, display image data to display the image on a display, and display image data information containing the capacity of the display image data are arranged in order, the data processing method comprising:
acquiring the display image data information from the image file holding unit and supplying the acquired information;
performing a seek operation from the end of the image file to acquire the display image data from the image file holding unit based on the capacity of the display image data contained in the display image data information that has been supplied; and
displaying the display image data on the display.

20. An image data structure, comprising:
thumbnail image data for thumbnail display of an image, main image data about the image, display image data to display the image on a display, and display image data information containing the capacity of the display image data all arranged in order;
wherein when a computer receives an instruction to display the image, it acquires the capacity of the display image data from the display image data information, accesses the image data structure from the end of the structure based on the capacity of the display image data to acquire the display image data, and displays the display image data on the display.
